(19) United States
(12) Patent Application Publication
(10) Pub. No.: US 2023/0261823 A1
(43) Pub. Date: Aug. 17, 2023

(54) METHOD AND APPARATUS FOR TRANSMITTING, RECEIVING AND MEASURING OF POSITIONING SIGNALS

(71) Applicant: Samsung Electronics Co., Ltd., Suwon-si (KR)

(72) Inventors: Qi XIONG, Beijing (CN); Pengru LI, Beijing (CN); Feifei SUN, Beijing (CN)

(21) Appl. No.: 18/166,809

(22) Filed: Feb. 9, 2023

(30) Foreign Application Priority Data
Feb. 11, 2022 (CN) 202210133251.1

(51) Int. Cl. H04L 5/00

(52) U.S. Cl. CPC H04L 5/0048; H04L 5/0078

(57) ABSTRACT

The disclosure relates to a 5G or 6G communication system for supporting a higher data transmission rate. A method for transmitting, receiving and measuring of positioning signal is provided. The method includes determining resource configuration information of a sounding reference signal (SRS) and configuration information of a first uplink signal, and transmitting SRS and the first uplink signal according to the determined the resource configuration information of SRS and the configuration information of the first uplink signal.

### CROSS-REFERENCE TO RELATED APPLICATION(S)

This application is based on and claims priority under 35 U.S.C. § 119(a) of a Chinese patent application number 202210133251.1, filed on Feb. 11, 2022, in the Chinese Intellectual Property Office, the disclosure of which is incorporated by reference herein in its entirety.

### BACKGROUND

### 1. Field

The disclosure relates to a field of wireless communication. More particularly, the disclosure relates to a method and device for transmitting, receiving and measuring of positioning signals.

### 2. Description of Related Art

5G mobile communication technologies define broad frequency bands such that high transmission rates and new services are possible, and can be implemented not only in “Sub 6 GHz” bands such as 3.5 GHz, but also in “Above 6GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for transmitting, receiving, and measuring of positioning signals.

Additional aspects will be set forth in part in the description which follows and, in part, will be apparent from the description, or may be learned by practice of the presented embodiments.

In accordance with an aspect of the disclosure, a method performed by a user equipment (UE) is provided. The method includes determining resource configuration information of a sounding reference signal SRS and configuration information of a first uplink signal, and transmitting SRS and the first uplink signal according to the determined the resource configuration information of SRS and the configuration information of the first uplink signal.

In accordance with another aspect of the disclosure a method performed by a user equipment (UE), wherein the configuration information of a first uplink signal includes time domain interval information of K2 time domain units for scheduling the first uplink signal; the time domain interval information is a time domain unit interval between a downlink signal scheduling the first uplink signal and the first uplink signal is provided.

In accordance with another aspect of the disclosure a method performed by user equipment (UE), wherein transmitting SRS and the first uplink signal includes: determining whether the first condition is satisfied according to the determined resource configuration information of SRS and configuration information of the first uplink signal; determining the timing of transmitting the first uplink signal according to the determination result, and transmitting SRS and the first uplink signal based on the timing of transmitting; wherein the first condition is that the time interval between the first uplink signal and its closest SRS is less than or not greater than a first threshold is provided.

In accordance with another aspect of the disclosure a method performed by user equipment (UE), wherein determining the timing of transmitting the first uplink signal according to the determination result, and transmitting SRS and the first uplink signal based on the timing of transmitting includes: the UE determines that the time domain unit interval information is N time units when the first condition is satisfied, where N is K2+delta time units; and/or the UE determines that the time domain unit interval information is N time units when the first condition is not satisfied, wherein N is K2 is provided.

In accordance with another aspect of the disclosure a method performed by user equipment (UE), wherein K2 is the maximum value in a set of configured time interval values is provided.

In accordance with another aspect of the disclosure a method performed by a user equipment (UE), wherein the delta time units are the number of time units related to subcarrier intervals is provided.

In accordance with another aspect of the disclosure a method performed by a user equipment (UE), including: receiving configuration information related to positioning reference signal (PRS) resources; determining selected downlink beam signal; determining the prioritized PRS resource to be measured and/or reported according to the received configuration information related to PRS resource and the determined selected downlink beam signal; measuring and/or reporting the measurement results according to prioritized PRS source to be measured and/or reported is provided.

In accordance with another aspect of the disclosure a method performed by a user equipment (UE), wherein the configuration information related to PRS resource includes one or more of the following: a mapping relationship between one PRS resource and one or more other PRS resources; information of transmitting angle corresponding to one PRS resource; quasi-collocated relationship between one PRS resource and one downlink beam signal is provided.

In accordance with another aspect of the disclosure a method performed by a user equipment (UE), wherein determining selected downlink beam signal includes one or more of the following: when reference signal receiving power (RSRP) of a downlink beam signal measured by the UE is higher than or not lower than a second threshold, the downlink beam signal is determined to be the selected downlink beam signal; if in the previous PRS measurement process, PRS with measured RSRP being higher than the second threshold is obtained, then the PRS is determined as the selected downlink beam signal; the downlink beam signal selected by the indication received from the base station equipment is provided.

In accordance with another aspect of the disclosure a method performed by user equipment (UE), wherein determining the prioritized PRS source to be measured and/or reported includes one or more of the following: according to the selected downlink beam signal and the quasi-collocated relationship, the PRS which is quasi-collocated with the selected downlink beam signal is determined as prioritized PRS resources to be measured and/or reported; the prioritized PRS resources to be measured and/or reported are determined according to obtaining of the PRS that is quasi-collocated with the selected downlink beam signal and its corresponding transmitting angle information is provided.

In accordance with another aspect of the disclosure a method performed by a user equipment (UE), wherein PRS with the same transmitting angle information is determined as prioritized PRS resources to be measured and/or reported according to obtaining of the PRS that is quasi-collocated with the selected downlink beam signal and its corresponding transmitting angle information is provided.

In accordance with another aspect of the disclosure provides a method performed by a user equipment (UE), wherein the PRS with the same transmitting angle information includes transmitting angle information within a certain range relative to the transmitting angle is provided.

In accordance with another aspect of the disclosure a method performed by a user equipment (UE), including a transceiver, and a processor coupled with the transceiver and configured to run any of the above methods is provided.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless network according to an embodiment of the disclosure;

FIG. 2A illustrates a wireless transmission path according to an embodiment of the disclosure;

FIG. 2B illustrates a wireless reception path according to an embodiment of the disclosure;

FIG. 3A illustrates a user equipment according to an embodiment of the disclosure;

FIG. 3B illustrates a base station according to an embodiment of the disclosure;

FIG. 4 illustrates various hardware components of a user equipment (UE) according to an embodiment of the disclosure; and

FIG. 5 illustrates various hardware components of a base station (BS) according to an embodiment disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. The description includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

The technical solution of the embodiments in the application can be applied to various communication systems, such as global system for mobile communications (GSM) system, code division a plurality of access (CDMA) system, wideband code division multiple access (WCDMA) system, general packet radio service (GPRS), long term evolution (LTE) system, LTE frequency division duplex (FDD) system, LTE time division duplex (TDD), universal mobile telecommunications system (UMTS), worldwide interoperability for microwave access (WiMAX) communication system, 5th generation (5G) system or new radio (NR), etc. In addition, the technical solution of the embodiments in the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

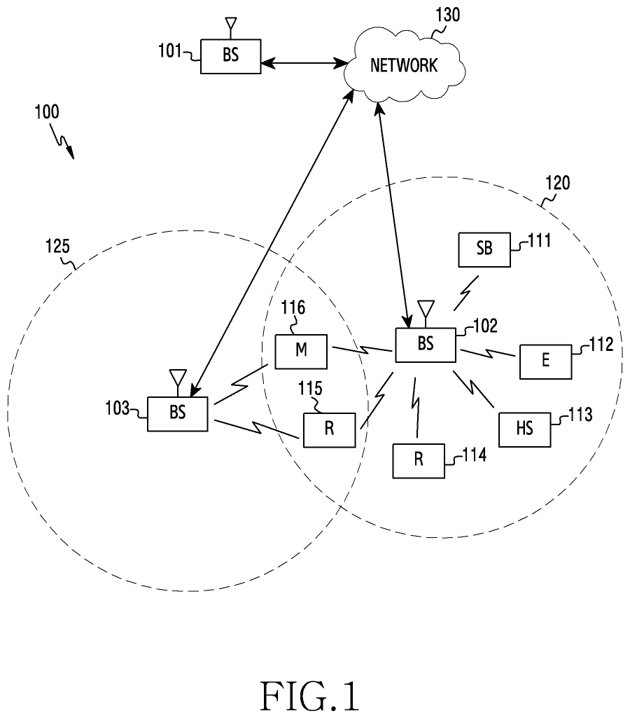

FIG. 1 illustrates a wireless network according to an embodiment of the disclosure.

Referring to FIG. 1, the embodiment of a wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one internet protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB), a UE 112, which may be located in an enterprise (E), a UE 113, which may be located in a WiFi Hotspot (HS), a UE 114, which may be located in a first residence (R), a UE 115, which may be located in a second residence (R), a UE 116, which may be a mobile device (M), such as a cellular phone, a wireless laptop computer, a wireless PDA, or the like. GNB 103 provides wireless broadband access to network 130 for a second plurality of UEs within a coverage area 125 of gNB 103. The second plurality of UEs include a UE 115 and a UE 116. In some embodiments of the disclosure, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments of the disclosure, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

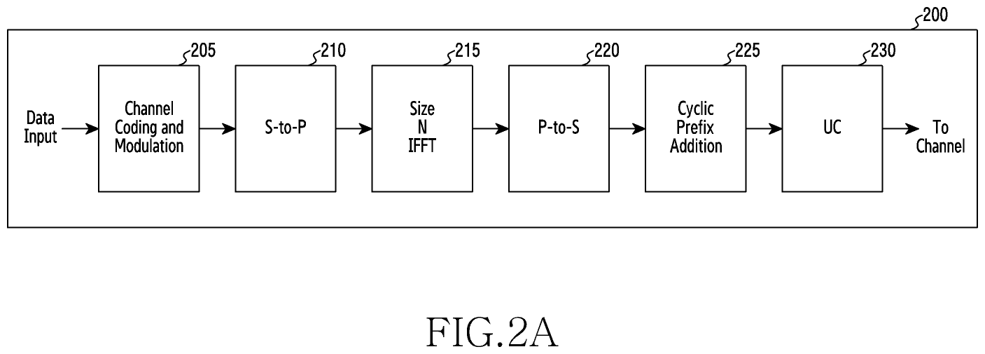

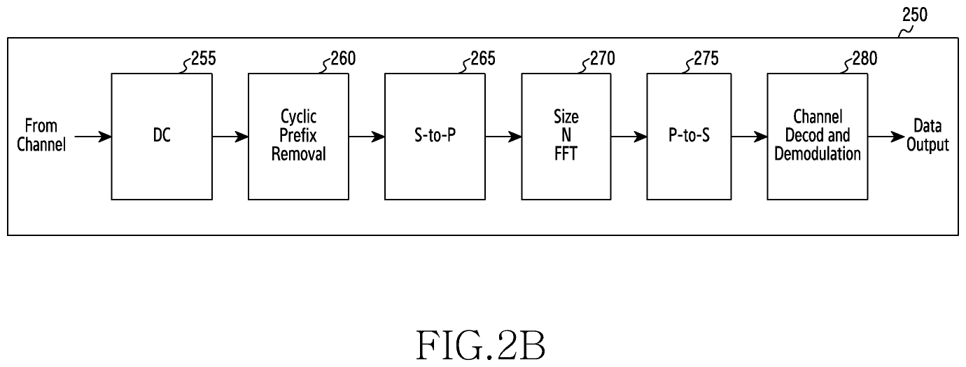

FIGS. 2A and 2B illustrate wireless transmission and reception paths according to various embodiments of the disclosure.

Referring to FIGS. 2A and 2B, a transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments of the disclosure, the reception path 250 is configured to support codebook designs and structures for systems with 2D antenna arrays as described in embodiments of the disclosure.

The transmission path 200 includes a channel coding and modulation block 205, a serial-to-parallel (S-to-P) block 210, a size N inverse fast fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. the serial-to-parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. the serial-to-parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete fourier transform (DFT) and inverse discrete fourier transform (IDFT) functions. It should be understood that for DFT and IDFT functions, the value of variable N may be any integer (such as 1, 2, 3, 4, or the like), while for FFT and IFFT functions, the value of variable N may be any integer which is a power of 2 (such as 1, 2, 4, 8, 16, or the like).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

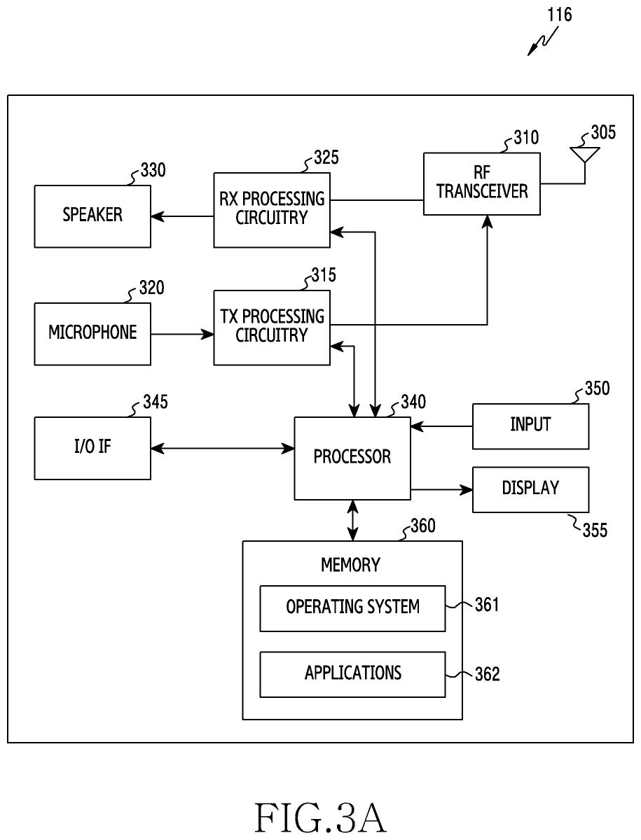

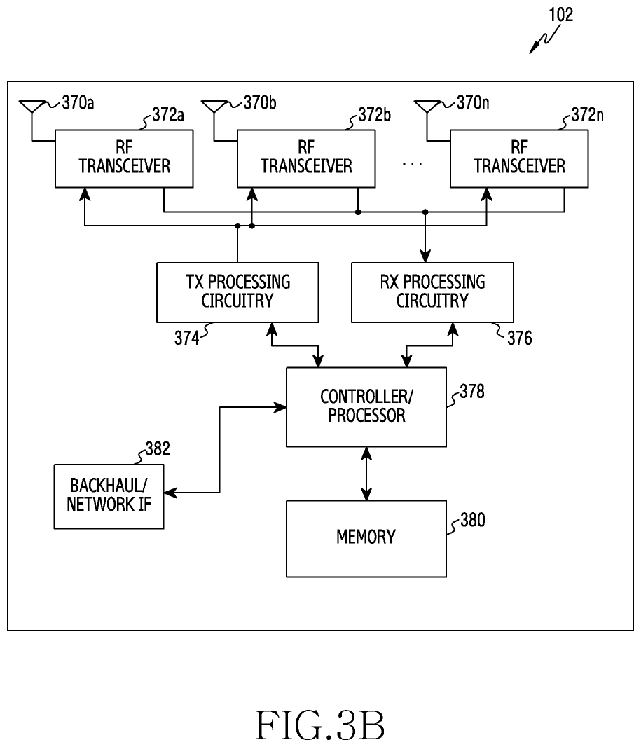

FIG. 3A illustrates a UE according to an embodiment of the disclosure.

Referring to FIG. 3A, the embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

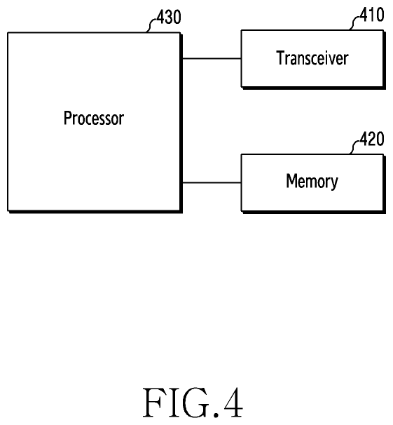

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362. However, the components of the UE 116 are not limited thereto. For example, the UE 116 may include more or fewer components than those described above. In addition, the UE 116 corresponds to the UE of the FIG. 4.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments of the disclosure, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments of the disclosure, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates gNB according to an embodiment of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

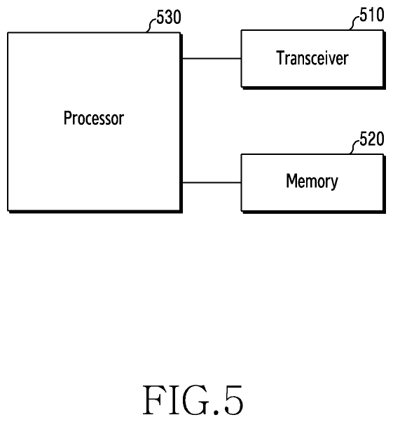

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments of the disclosure, one or more of the plurality of antennas 370a-370n include a 2D antenna array. gNB 102 also includes a controller/processor 378, a memory 380, and a backhaul or network interface 382. However, the components of the BS 102 are not limited thereto. For example, the BS 102 may include more or fewer components than those described above. In addition, the BS 102 corresponds to the base station of the FIG. 5.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in gNB 102. In some embodiments of the disclosure, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments of the disclosure, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments of the disclosure, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also referred as a time unit) in this application can be one orthogonal frequency-division multiplexing (OFDM) symbol, one OFDM symbol group (including multiple OFDM symbols), one slot, one slot group (including multiple slots), one subframe, one subframe group (including multiple subframes), one system frame and one system frame group (including multiple system frames); it can also be an absolute time unit, such as 1 ms, 1 s, etc.; a time unit can also be a combination of multiple granularities, such as N1 slots plus N2 OFDM symbols.

The frequency domain unit in this application can be one subcarrier, one subcarrier group (including multiple subcarriers), one resource block (RB) (also referred as physical resource block (PRB)), one resource block group (including multiple RBs), one bandwidth part (BWP), one band part group (including multiple BWPs), one frequency band/carrier, one frequency band/carrier group, it can also be an absolute frequency domain unit, such as 1 Hz, 1 kHz, or the like , a frequency domain unit can also be a combination of multiple granularities, such as M1 PRBs plus M2 subcarriers.

Various embodiments of the disclosure are further described below with reference to the accompanying drawings.

Text and drawings are provided as examples only to help readers understand the disclosure. They are not intended and should not be interpreted as limiting the scope of this disclosure in any way. Although certain embodiments and examples have been provided, based on the disclosure herein, it will be apparent to those skilled in the art that changes may be made to the illustrated embodiments and examples without departing from the scope of the disclosure.

It should be further understood that the word “include” used in the specification of this disclosure means the presence of stated features, integers, steps, operations, elements and/or components, but does not exclude the presence or addition of one or more other features, integers, steps, operations, elements, components and/or groups thereof. It should be understood that when we say that an element is “connected” or “coupled” to another element, it may be directly connected or coupled to other elements, or there may be intermediate elements. In addition, “connected” or “coupled” used herein may include wireless connection or wireless coupling. As used herein, the phrase “and/or” includes all or any unit and all combinations of one or more associated listed items.

It can be understood by those skilled in the art that unless otherwise defined, all terms (including technical terms and scientific terms) used herein have the same meanings as those generally understood by those skilled in the art to which this disclosure belongs. It should also be understood that terms such as those defined in a general dictionary should be understood to have meanings consistent with those in the context of the prior art, and will not be interpreted in idealized or overly formal meanings unless specifically defined as here.

As can be understood by those skilled in the art, “terminal” and “terminal device” used herein include not only equipment of wireless signal receiver with no transmitting capability, but also equipment of receiving and transmitting hardware with equipment of receiving and transmitting hardware capable of bidirectional communication on a bidirectional communication link. In the embodiment of this disclosure, when the sidelink communication system is a V2X system, “user equipment (UE)”, “terminal” and “terminal device” can be various types such as vehicles, infrastructures and pedestrians. Such devices may include cellular or other communication devices with single-line displays or multi-line displays or cellular or other communication devices without multi-line displays, personal communications service (PCS), which can combine voice, data processing, fax and/or data communication capabilities, personal digital assistant (PDA), which can include radio frequency receivers, pagers, internet/intranet access, web browsers, notepads, calendars and/or global positioning system (GPS) receivers, laptops and/or palmtop computers or other devices of the related art having and/or including radio frequency receivers. As used herein, “terminal” and “terminal device” can be portable, transportable, installed in vehicles (aviation, sea transportation and/or land), or suitable and/or configured to run locally, and/or in distributed form, running at any other position on the earth and/or space. As used herein, “terminal” and “terminal device” can also be communication terminals, internet terminals and music/video playing terminals, such as PDA, mobile internet device (MID) and/or mobile phones with music/video playing functions, as well as smart TVs, set-top boxes and other devices.

Without departing from the scope of the disclosure, the term “transmit” in the disclosure can be used interchangeably with “transmission”, “report” and “notify”.

Text and drawings are provided as examples only to help readers understand the disclosure. They are not intended and should not be interpreted as limiting the scope of this disclosure in any way. Although certain embodiments and examples have been provided, based on the disclosure herein, it will be apparent to those skilled in the art that changes may be made to the illustrated embodiments and examples without departing from the scope of the disclosure.

The transmission links of the wireless communication system mainly include the downlink communication link from 5G gNB to user equipment (UE) and the uplink communication link from UE to the network.

The nodes used for measuring of positioning in wireless communication systems (e.g., the current wireless communication system) include: UE that initiates the positioning request message, location management function (LMF) that is used for UE positioning and position assistance data delivery, gNB or transmission-reception point (TRP) that broadcasts position assistance data and performs uplink positioning measurement, and UE that is used for downlink positioning measurement.

In an embodiment of the disclosure, in the current wireless communication system, 5G NR (New Radio, NR) can be switched among three kings of radio resource control (RRC) states, namely RRC_CONNECTED state, RRC_INACTIVE state and RRC_IDLE state. Compared with LTE, in order to further reduce signaling overhead and power consumption, RRC_INACTIVE state is introduced in 5G to reduce control plane delay and terminal power consumption. RRC_INACTIVE state can be mutually converted with RRC_CONNECTED state, or can be entered into RRC_IDLE state by releasing RRC connection.

According to the UE capability, UE may configure sounding reference signal SRS (hereinafter referred to as SRS) resources for positioning in RRC_INACTIVE state, including frequency position, bandwidth, numerology configuration and cyclic prefix CP length. In the RRC_INACTIVE state, the other uplink bandwidth part (UL BWP) which carries one or more SRS received by the UE differs from the initial uplink bandwidth part (UL BWP) in: frequency position and/or bandwidth and/or numerology configuration and/or cyclic prefix CP length, then UE may need to transmit the first uplink signal in the initial uplink bandwidth part (the first uplink signal may be a random access signal and/or PUSCH and/or PUCCH transmission), in the case that the first uplink signal transmission and the SRS transmission meet at least one or a combination of the following conditions:
The time interval between the first uplink signal transmission and the SRS transmission is less than (not more than) a first threshold T1,
the first uplink signal transmission and the SRS transmission overlap in time,
the first uplink signal transmission and the SRS transmission overlap in frequency domain.

If the priority of the first uplink signal of the UL is higher than that of the SRS resource, the UE needs to discard the SRS transmission, that is, SRS is not transmitted,

In an implementation, in order to ensure the SRS transmission, the first uplink signal transmission received by the UE can meet one or a combination of the following conditions:
Including a time interval between a downlink signal scheduling the first uplink signal and the first uplink signal, which is N time units, in an implementation
   When the time interval between the first uplink signal and the SRS closest to the first uplink signal is less than or not greater than the first threshold T1 (and/or when the first uplink signal and the closest SRS overlap in time or frequency domain), and/or after using the configurable maximum K2 time units, the time interval between the first uplink signal and the SRS closest to the first uplink signal cannot be made greater than or not less than the first threshold T1, then the N time units are the K2 time units (configured as the basis) superimposed with one delta time unit, in an implementation,
      The delta time units may be the number of time units related to subcarrier intervals, and/or
      The delta may be a positive value (that is, timing of the first uplink signal will be K2 time units plus delta time units afterwards), and/or
      The delta may be a negative value (that is, timing of the first uplink signal will be K2 time units minus delta time units backwards),
   When the time interval between the first uplink signal and the SRS closest to the first uplink signal is greater than or not less than a first threshold T1, the N time units are K2 time units configured by the base station equipment, particularly, preferably, delta=0 at this time.
in an implementation, K2 may be the maximum value among optional configuration values, namely K2MAX, that is, K2MAX is used to be superimposed with delta,
in an implementation, that delta time unit may reuse the delta value in random access message 3,
in an implementation, the downlink signal may be a downlink control channel and/or higher layer signaling,
in an implementation, the first threshold T1 may be
   The processing time reported by the UE (for example, including the preparation time for processing BWP conversion, processing the first uplink signal or SRS signal, or the like), and/or,
   time threshold configured by the base station equipment,

In this way, the UE can transmit the first uplink signal and the SRS so as to measure and acquire positioning information.

In another embodiment of the disclosure, in the method of obtaining positioning information based on angle, for example, the UE needs to measure a downlink positioning signal (e.g., positioning reference signal, PRS), the UE may receive one or more PRS resource configuration sets and configuration information related to PRS resources, wherein the configuration related to PRS resource information may include a combination of one or more of the following:
Among the PRS resources received by UE, a given PRS resource is mapped to one or more other PRS resources, the mapping of the given PRS resource may be the same PRS resource set or a different PRS resource set as the other one or more PRS resources,
Among the PRS resources received by the UE, a given PRS resource has corresponding transmitting angle information, for example, only that PRS signal is transmitted by the base station equipment with a 30-degree beam, wherein 30 degrees may be based on the local coordinates of the base station equipment or the global coordinates of the whole network,
Among the PRS resources received by UE, a given PRS resource has a downlink beam signal (e.g., synchronization signal block (SSB) and/or channel state information reference signal (CSI-RS) and/or PRS) which is quasi-collocated (QCL), that is, PRS1 and SSB1 are configured to be quasi-collocated, the UE may consider that the beam direction for transmitting SSB1 is the same as that for transmitting PRS1,

After obtaining the configured PRS resources, the UE needs to measure PRS. Considering that the base station equipment may transmit PRS signals in multiple directions, that is, transmit different PRS signals with different directional beams, the UE may need to detect all PRS signals. For PRS signals in some directions, strong receiving power (RSRP) can be detected, that is, the RSRP is higher than or not lower than the second threshold P, for PRS signals in some directions, weak receiving power (RSRP), which is lower or not higher than the second threshold P, can be detected. According to the method provided by the disclosure, the UE can be made to predetermine to preferentially receive one or more PRS signals, while not receive or receive other PRS in a low priority manner,

The UE obtains the selected downlink beam signal by a certain way, which includes one or a combination of the following:
in the process of measuring some downlink beam signals, for example, random access, cell selection and beam management, the UE measures the downlink beam signals, and the UE will obtain the selected message beam signals, for example, when the RSRP of the measured downlink beam signal is higher than the second threshold P, the UE determines that the measured downlink beam signal is the selected downlink beam signal, the number of the selected downlink beam signals may be one (for example, the one with highest RSRP) or more (for example, all downlink beam signals with RSRP higher than the second threshold P),
the downlink beam signal with the measured RSRP higher than the second threshold P, which is obtained in the previous PRS measurement process,
the downlink beam signal selected by UE by the indication received from the base station equipment, for example, the UE feeds back the measured RSRP of the downlink beam signal to the base station equipment, the base station device determines the selected downlink beam signal and then informs the UE of the selected downlink beam signal index,
the downlink beam signal selected by UE by the indication received from the base station equipment, for example, the UE transmits an uplink reference signal, and then the base station device determines the selected uplink reference signal (for example, the uplink reference signal with RSRP is higher than the third threshold P3) by receiving the measured RSRP of the uplink reference signal, When the transmitting beam for transmitting the uplink reference signal is corresponding to a given downlink beam reference signal (for example, according to the configuration of the base station and/or beam correspondence, the UE transmits the uplink reference signal using the transmitting beam corresponding to the receiving beam of a certain downlink beam reference signal), then the downlink beam reference signal is the selected downlink beam signal,

The elaboration to the method of the embodiment is made below with the following case as example: in which the downlink beam signal is SSB, the elaboration can be expanded to other downlink beam signals,

According to the selected downlink beam signal and the configuration information related to the PRS resources, UE determines the prioritized PRS resources to be measured and reported, the specific ways of determination include one or more of the following:
According to the selected downlink beam signal (for example, SSB1) and the configuration information of quasi-collocation, the UE obtains a PRS which is quasi-collocated with the downlink beam signal, for example, PRS1, the PRS1 can be used as a prioritized PRS resource to be measured and/or reported, preferably, the PRS resources mapped to PRS are also prioritized PRS resources to be measured and/or reported, for example, PRS resources mapped to PRS1 are also prioritized PRS resources to be measured and/or reported,
According to the selected downlink beam signal (for example, SSB1) and the configuration information of quasi-collocation, the UE obtains a PRS which is quasi-collocated with the downlink beam signal, for example, PRS1, according to the transmitting angle information corresponding to PRS resources, the transmitting angle information corresponding to PRS1 is obtained, and then all PRS with the same transmitting angle information are determined as prioritized PRS resources to be measured and/or reported,
   in an implementation, the same transmitting angle information can be the transmitting angle information corresponding to the PRS1 within a certain range. For example, if the transmitting angle information corresponding to the PRS1 is 30 degrees and the certain range is plus or minus 15 degrees, all the transmitting angle information between 30-15=15 degrees and 30+15=45 degrees can be considered as having the same transmitting angle information, and PRS resources corresponding to the transmitting angle information are the prioritized PRS resource to be measured and/or measured.

After determining the prioritized PRS resources to be measured and/or reported, the UE can preferentially measure the PRS resources and/or preferentially report the measurement results to the base station equipment or LMF.

FIG. 4 illustrates a structure of a UE according to an embodiment of the disclosure.

Referring to FIG. 4, the UE according to an embodiment may include a transceiver 410, a memory 420, and a processor 430. The transceiver 410, the memory 420, and the processor 430 of the UE may operate according to a communication method of the UE described above. However, the components of the UE are not limited thereto. For example, the UE may include more or fewer components than those described above. In addition, the processor 430, the transceiver 410, and the memory 420 may be implemented as a single chip. Also, the processor 430 may include at least one processor. Furthermore, the UE of FIG. 4 corresponds to the UE of the FIG. 3A.

The transceiver 410 collectively refers to a UE receiver and a UE transmitter, and may transmit/receive a signal to/from a base station or a network entity. The signal transmitted or received to or from the base station or a network entity may include control information and data. The transceiver 410 may include a RF transmitter for up-converting and amplifying a frequency of a transmitted signal, and a RF receiver for amplifying low-noise and down-converting a frequency of a received signal. However, this is only an example of the transceiver 410 and components of the transceiver 410 are not limited to the RF transmitter and the RF receiver.

Also, the transceiver 410 may receive and output, to the processor 430, a signal through a wireless channel, and transmit a signal output from the processor 430 through the wireless channel

The memory 420 may store a program and data required for operations of the UE. Also, the memory 420 may store control information or data included in a signal obtained by the UE. The memory 420 may be a storage medium, such as read-only memory (ROM), random access memory (RAM), a hard disk, a CD-ROM, and a DVD, or a combination of storage media.

The processor 430 may control a series of processes such that the UE operates as described above. For example, the transceiver 410 may receive a data signal including a control signal transmitted by the base station or the network entity, and the processor 430 may determine a result of receiving the control signal and the data signal transmitted by the base station or the network entity.

FIG. 5 illustrates a structure of a base station according to an embodiment of the disclosure.

Referring to FIG. 5, the base station according to an embodiment may include a transceiver 510, a memory 520, and a processor 530. The transceiver 510, the memory 520, and the processor 530 of the base station may operate according to a communication method of the base station described above. However, the components of the base station are not limited thereto. For example, the base station may include more or fewer components than those described above. In addition, the processor 530, the transceiver 510, and the memory 520 may be implemented as a single chip. Also, the processor 530 may include at least one processor. Furthermore, the base station of FIG. 5 corresponds to the BS 102 of the FIG. 3B.

The transceiver 510 collectively refers to a base station receiver and a base station transmitter, and may transmit/receive a signal to/from a terminal (UE) or a network entity. The signal transmitted or received to or from the terminal or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the base station. Also, the memory 520 may store control information or data included in a signal obtained by the base station. The memory 520 may be a storage medium, such as read-only memory (ROM), random access memory (RAM), a hard disk, a CD-ROM, and a DVD, or a combination of storage media.

The processor 530 may control a series of processes such that the base station operates as described above. For example, the transceiver 510 may receive a data signal including a control signal transmitted by the terminal, and the processor 530 may determine a result of receiving the control signal and the data signal transmitted by the terminal.

In one embodiment, a method performed by a user equipment (UE), the method comprising: determining resource configuration information of a sounding reference signal (SRS) and configuration information of a first uplink signal; transmitting, to base station, the SRS and the first uplink signal according to the determined the resource configuration information of SRS and the configuration information of the first uplink signal.

In one embodiment, wherein the configuration information of the first uplink signal includes time domain interval information of K2 time domain units for scheduling the first uplink signal; wherein the time domain interval information is a time domain unit interval between a downlink signal scheduling the first uplink signal and the first uplink signal.

In one embodiment, wherein the transmitting , to base station, the SRS and the first uplink signal comprising: determining whether a first condition is satisfied according to the determined resource configuration information of SRS and configuration information of the first uplink signal; determining the timing of transmitting the first uplink signal according to the determination result, and transmitting SRS and the first uplink signal based on the timing of transmitting; wherein the first condition is that the time interval between the first uplink signal and its closest SRS is less than or not greater than a first threshold.

In one embodiment, wherein the determining the timing of transmitting the first uplink signal according to the determination result, and transmitting SRS and the first uplink signal based on the timing of transmitting comprising: determining the time domain unit interval information which is N time units when the first condition is satisfied, where N is K2+delta time units; and/or determining the time domain unit interval information which is N time units when the first condition is not satisfied, wherein N is K2.

In one embodiment, wherein the K2 is the maximum value in a set of configured time interval values.

In one embodiment, wherein the delta time units are the number of time units related to subcarrier intervals.

In one embodiment, a method performed by a base station, the method comprising: receiving, from a user equipment (UE), a sounding reference signal (SRS) and the first uplink signal according to the determined the resource configuration information of SRS and the configuration information of the first uplink signal, wherein the resource configuration information of the SRS and configuration information of the first uplink signal are determined by the UE.

In one embodiment, wherein the configuration information of the first uplink signal includes time domain interval information of K2 time domain units for scheduling the first uplink signal; wherein the time domain interval information is a time domain unit interval between a downlink signal scheduling the first uplink signal and the first uplink signal.

In one embodiment, wherein the transmitting SRS and the first uplink signal comprising: receiving, from the UE, the SRS and the first uplink signal based on the timing of transmitting determined according to a determination result; wherein the determination result whether a first condition is satisfied according to the determined resource configuration information of SRS and configuration information of the first uplink signal; wherein the first condition is that the time interval between the first uplink signal and its closest SRS is less than or not greater than a first threshold.

In one embodiment, wherein the time domain unit interval information is determined as N time units when the first condition is satisfied, where N is K2+delta time units; and/or wherein the time domain unit interval information is determined as N time units when the first condition is not satisfied, wherein N is K2.

In one embodiment, wherein the K2 is the maximum value in a set of configured time interval values.

In one embodiment, wherein the delta time units are the number of time units related to subcarrier intervals.

In one embodiment, a method performed by a user equipment (UE), includes:

receiving configuration information related to positioning reference signal (PRS) resources; determining selected downlink beam signal; determining the prioritized PRS resource to be measured and/or reported according to the received configuration information related to PRS resource and the determined selected downlink beam signal; measuring and/or reporting the measurement results according to prioritized PRS source to be measured and/or reported.

In one embodiment, wherein, the configuration information related to PRS resource includes one or more of the following: a mapping relationship between one PRS resource and one or more other PRS resources; information of transmitting angle corresponding to one PRS resource; quasi-collocated relationship between one PRS resource and one downlink beam signal.

In one embodiment, wherein determining selected downlink beam signal includes one or more of the following: when reference signal receiving power (RSRP) of a downlink beam signal measured by the UE is higher than or not lower than a second threshold, the downlink beam signal is determined to be the selected downlink beam signal; if in the previous PRS measurement process, PRS with measured RSRP being higher than the second threshold is obtained, then the PRS is determined as the selected downlink beam signal; the downlink beam signal selected by the indication received from the base station equipment.

In one embodiment, wherein determining the prioritized PRS source to be measured and/or reported includes one or more of the following: according to the selected downlink beam signal and the quasi-collocated relationship, the PRS which is quasi-collocated with the selected downlink beam signal is determined as prioritized PRS resources to be measured and/or reported; the prioritized PRS resources to be measured and/or reported are determined according to obtaining of the PRS that is quasi-collocated with the selected downlink beam signal and its corresponding transmitting angle information.

In one embodiment, wherein PRS with the same transmitting angle information is determined as prioritized PRS resources to be measured and/or reported according to obtaining of the PRS that is quasi-collocated with the selected downlink beam signal and its corresponding transmitting angle information.

In one embodiment, wherein the PRS with the same transmitting angle information includes transmitting angle information within a certain range relative to the transmitting angle.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

It can be understood by those skilled in the art that the disclosure includes devices for performing one or more of the operations described in the disclosure. These devices may be specially designed and manufactured for the desired purposes, or they may include known devices in general-purpose computers. These devices have computer programs stored therein that are selectively activated or reconstructed. Such computer programs may be stored in device (e.g., computer) readable medium, including but not limited to, any type of disk including floppy disk, hard disk, optical disk, CD-ROM, and magnetic-optical disk, Read-Only Memory (ROM), Random Access Memory (RAM), Erasable Programmable Read-Only Memory (EPROM), Electrically Erasable Programmable Read-Only Memory (EEPROM), flash memory, magnetic card or optical card. That is, readable medium includes any medium that stores or transmits information in a readable form by a device (e.g., a computer).

It can be understood by those skilled in the art that each block in these structural diagrams and/or block diagrams and/or flow diagrams and combinations of blocks in these structural diagrams and/or block diagrams and/or flow diagrams can be implemented by computer program instructions. It can be understood by those skilled in the art that these computer program instructions can be provided to processors of general-purpose computers, special-purpose computers or other programmable data processing methods for implementation, so that the schemes specified in the block or blocks of the structural diagrams and/or block diagrams and/or flow diagrams of the disclosure can be executed by the processors of the computers or other programmable data processing methods.

Those skilled in the art can understand that steps, measures and schemes in various operations, methods and flows that have been discussed in this disclosure can be alternated, changed, combined or deleted. Further, other steps, measures and schemes in various operations, methods and flows already discussed in this disclosure can also be alternated, changed, rearranged, decomposed, combined or deleted. Furthermore, steps, measures and schemes in various operations, methods and flows disclosed in this disclosure in the prior art can also be alternated, changed, rearranged, decomposed, combined or deleted.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE), the method comprising:
determining resource configuration information of a sounding reference signal (SRS) and configuration information of a first uplink signal; and
transmitting, to base station, the SRS and the first uplink signal according to the determined the resource configuration information of SRS and the configuration information of the first uplink signal.

2. The method of claim 1,
wherein the configuration information of the first uplink signal includes time domain interval information of K2 time domain units for scheduling the first uplink signal; and
wherein the time domain interval information is a time domain unit interval between a downlink signal scheduling the first uplink signal and the first uplink signal.

3. The method of claim 2, wherein the transmitting, to base station, of the SRS and the first uplink signal comprises:
determining whether a first condition is satisfied according to the determined resource configuration information of SRS and configuration information of the first uplink signal, and
determining the timing of transmitting the first uplink signal according to the determination result, and transmitting SRS and the first uplink signal based on the timing of transmitting,
wherein the first condition is that the time interval between the first uplink signal and its closest SRS is less than or not greater than a first threshold.

4. The method of claim 3, wherein the determining the timing of transmitting of the first uplink signal according to the determination result, and transmitting SRS and the first uplink signal based on the timing of transmitting comprises:
determining the time domain unit interval information which is N time units when the first condition is satisfied, where N is K2+delta time units; and/or
determining the time domain unit interval information which is N time units when the first condition is not satisfied, wherein N is K2.

5. The method of claim 4, wherein the K2 includes a maximum value in a set of configured time interval values.

6. The method of claim 4, wherein the delta time units include a number of time units related to subcarrier intervals.

7. A method performed by a base station, the method comprising:
receiving, from a user equipment (UE), a sounding reference signal (SRS) and the first uplink signal according to the determined the resource configuration information of SRS and the configuration information of the first uplink signal,
wherein the resource configuration information of the SRS and configuration information of the first uplink signal are determined by the UE.

8. The method of claim 7,
wherein the configuration information of the first uplink signal includes time domain interval information of K2 time domain units for scheduling the first uplink signal, and
wherein the time domain interval information is a time domain unit interval between a downlink signal scheduling the first uplink signal and the first uplink signal.

9. The method of claim 8, wherein the receiving of SRS and the first uplink signal comprises:
receiving, from the UE, the SRS and the first uplink signal based on the timing of transmitting determined according to a determination result,
wherein the determination result includes whether a first condition is satisfied according to the determined resource configuration information of SRS and configuration information of the first uplink signal, and
wherein the first condition is that the time interval between the first uplink signal and its closest SRS is less than or not greater than a first threshold.

10. The method of claim 9,
wherein the time domain unit interval information is determined as N time units when the first condition is satisfied, where N is K2+delta time units, and/or
wherein the time domain unit interval information is determined as N time units when the first condition is not satisfied, wherein N is K2.

11. The method of claim 10, wherein the K2 includes a maximum value in a set of configured time interval values.

12. The method of claim 10, wherein the delta time units include a number of time units related to subcarrier intervals.

13. A user equipment (UE), the UE comprising:
a transceiver, and
at least one processor operatively coupled with the transceiver and configured to: determine resource configuration information of a sounding reference signal (SRS) and configuration information of a first uplink signal, and
transmit, to base station, the SRS and the first uplink signal according to the determined the resource configuration information of SRS and the configuration information of the first uplink signal.

14. The UE of claim 13,
wherein the configuration information of the first uplink signal includes time domain interval information of K2 time domain units for scheduling the first uplink signal, and
wherein the time domain interval information is a time domain unit interval between a downlink signal scheduling the first uplink signal and the first uplink signal.

15. The UE of claim 14, wherein the at least one processor is further configured to:
determine whether a first condition is satisfied according to the determined resource configuration information of SRS and configuration information of the first uplink signal, and
determine the timing of transmitting the first uplink signal according to the determination result, and transmit SRS and the first uplink signal based on the timing of transmitting,
wherein the first condition is that the time interval between the first uplink signal and its closest SRS is less than or not greater than a first threshold.

16. The UE of claim 15, wherein at least one processor is further configured to:
determine the time domain unit interval information which is N time units when the first condition is satisfied, where N is K2+delta time units, and/or
determine the time domain unit interval information which is N time units when the first condition is not satisfied, wherein N is K2.

17. The UE of claim 16, wherein the K2 includes a maximum value in a set of configured time interval values.

18. The UE of claim 16, wherein the delta time units includes a number of time units related to subcarrier intervals.
